(19) United States
(12) Patent Application Publication
(10) Pub. No.: US 2025/0382031 A1
(43) Pub. Date: Dec. 18, 2025

(54) Drag-Reducing Structure

(71) Applicant: BLUENOSE TECHNOLOGIES LTD, London (GB)

(72) Inventors: Léon Arthur Grillet, London (GB); Joë Toidet Sangar, London (GB)

(21) Appl. No.: 18/878,483

(22) PCT Filed: Jun. 26, 2023
(86) PCT No.: PCT/GB2023/051669

§ 371 Date: Dec. 23, 2024

(30) Foreign Application Priority Data
Jun. 24, 2022 (GB) 2209324.9

(51) Int. Cl. B63B 1/32; B63B 17/00; G06F 30/20

(52) U.S. Cl. CPC B63B 1/322; B63B 17/00; G06F 30/20

(57) ABSTRACT

A structure (1050, 1060) for reducing drag force exerted on a ship. The structure comprises a support structure (1050-2), (1060-2) and a surface cover (1010-3). The support structure is attachable to the ship and is connected to the surface cover to provide and maintain a structure shape. which is configured to reduce drag forces exerted on the ship. The support structure is adjustable.

The invention relates generally to methods for reducing drag forces exerted on vehicles. More particularly, but not exclusively, the invention relates to structures, and methods for producing structures, for reducing the drag forces exerted on cargo ships.

### BACKGROUND

Reducing the amount of fuel consumed by a vehicle is desirable for a variety of reasons. Fuel is expensive, so reducing the amount of fuel required for a vehicle to travel a certain distance reduces the costs associated with running the vehicle. Further, using less fuel enables a vehicle to travel greater distances in one journey. Particularly for fossil fuels, reducing fuel consumption helps to reduce the environmental impact of the vehicle.

One of the factors affecting fuel consumption is the size and presence of drag forces exerted on a vehicle while it travels. Drag forces impede the vehicle's motion, and additional fuel is used to overcome the effect of the drag forces. Reducing the size of the drag forces exerted on a vehicle improves the vehicle's fuel consumption.

A cargo ship is an example of a vehicle which experiences large drag forces. These forces result primarily from the vertical sides of cargo-holding shipping containers placed on, usually stacked in multiples several containers wide, several containers deep and several containers high, which provide surfaces for oncoming wind to exert force against.

Modern ships are now designed with aerodynamics in mind to reduce drag forces. However, many container ships were built before drag forces were considered or understood to be a serious problem. As a result, most of the ships currently in use were not designed for a market working with high fuel costs and have poor fuel consumption. It is not feasible to simply dispose of and replace a ship when it is not adapted to the market, since the average investment cost for a ship with a loading capacity above 9.500 TEU (Twenty-foot Equivalent Unit) is $100 million.

The present invention has been devised with the foregoing in mind.

### SUMMARY OF INVENTION

According to a first aspect of the invention, there is provided a method for forming a drag-reducing structure. The method may be a method for forming a drag-reducing structure for reducing drag forces exerted on a vehicle. The method may be a method for forming a drag-reducing structure for reducing drag forces exerted on a cargo ship.

The method may comprise providing one or more working parameters. The method may comprise generating, based on the one or more working parameters, an optimal drag-reducing structure shape. The optimal drag-reducing structure shape may be configured to reduce drag forces exerted on the vehicle. The optimal drag-reducing structure shape may be optimised to reduce the drag force exerted on the specific vehicle for which the method is being used.

The method may be used to provide a user with an optimal drag-reducing structure shape. The user may then form/build a structure based on the optimal drag-reducing structure shape.

The method may comprise forming a drag-reducing structure based on the optimal drag-reducing structure shape. The method may comprise forming a drag-reducing structure having the optimal drag-reducing structure shape. Forming a drag-reducing structure may comprise building a drag-reducing structure.

The method may comprise attaching the drag-reducing structure to the vehicle. The method may comprise attaching the drag-reducing structure to the vehicle via one or more tensioned cables. The method may comprise attaching the drag-reducing structure to the vehicle via a plurality of bolts.

The drag-reducing structure may be configured to be positioned on the vehicle. The vehicle may be a cargo ship and the drag-reducing structure may be configured to fit on the front deck of the cargo ship. The drag-reducing structure may be configured to fit on any other surface of the ship in order to reduce drag. For example, the drag-reducing structure can be configured to fit on the bridge of the ship, at the back of the ship behind shipping containers, or in any other region of the ship.

A drag-reducing structure reduces the turbulent airflow around a vehicle in order to reduce the drag forces exerted on the vehicle. For example, a drag-reducing structure can reduce the turbulent airflow at the front of a cargo ship by redirecting airflow over the top of shipping containers. The drag-reducing structure redirects air away from areas of the vehicle where turbulent airflow would occur.

Providing one or more working parameters may comprise recording one or more parameters. Providing one or more working parameters may comprise measuring one or more parameters associated with the vehicle. Providing one or more working parameters may comprise inputting the one or more parameters into a computer. A user may record and/or obtain working parameters prior to performing the method.

Providing one or more working parameters may comprise measuring one or more parameters associated with the vehicle using recording equipment (e.g., drones, cameras, video recorders) and/or artificial intelligence.

Working parameters may be specific to a vehicle. The working parameters may define the size of the vehicle. The working parameters may define the shape of the vehicle. The working parameters may define the position, shape, and size of a region on the vehicle where the drag-reducing structure may be positioned. Working parameters may define aspects of the vehicle. Working parameters may define features a journey a vehicle may take (e.g., length of the journey, wind conditions on the journey, etc.). The working parameters may define the position and size of shipping containers on a cargo ship.

Using working parameters to generate an optimal drag-reducing structure enables the creation of bespoke drag-reducing structures which are optimised for use with a specific vehicle. Using working parameters also enables the creation of a drag-reducing structure optimised to reduce drag on specific journeys/routes, and/or under specific conditions. Optimising the shape of the drag-reducing structure for a specific vehicle reduces the drag forces exerted on the vehicle when compared with a vehicle having no drag-reducing structure, or a standardised (i.e., non-optimised) drag-reducing structure. Using working parameters to generate an optimal drag-reducing structure shape enables the creation of a drag-reducing structure optimised to redirect airflow over the top of cargo carrying shipping containers on a cargo ship.

At least one of the one or more working parameters may be: average vehicle speed, maximum vehicle speed, maximum vehicle load capacity, or average vehicle load capacity, vehicle shape, vehicle layout, vehicle size, or the position of equipment/apparatus on the vehicle.

The vehicle may be a ship. The vehicle may be a cargo ship. At least one of the one or more working parameters may be: average cruising speed, maximum cruising speed, maximum load capacity, average load capacity, front deck shape, front deck layout, front deck size, ship size, ship shape, position of equipment on the ship, positions of shipping containers on the ship, or dimensions of shipping containers on the ship.

The optimal drag-reducing structure shape may be generated using an algorithm. The algorithm may be executed on a computer. The algorithm may be executed on one or more processors. The algorithm may be configured to produce an optimal drag-reducing structure shape optimised to reduce drag forces exerted on the vehicle.

Using an algorithm to generate the optimal drag-reducing structure shape enables the drag-reducing structure to be optimised for a specific vehicle without requiring an engineer or relevant expert to perform all the relevant calculations.

The algorithm may generate the optimal structure shape iteratively. The algorithm may generate a starting shape and iteratively alter the shape to optimise it for reducing drag. Each shape iteration may have improved drag characteristics over the previous shape iteration. Each shape iteration may be generated based on the drag characteristics of the previous shape iteration. The algorithm may optimise the shape using artificial intelligence. The algorithm may optimise the shape using machine learning.

The algorithm may be configured to determine the optimal drag-reducing structure shape by:
(i) generating a first shape and designating it as the current best shape;
(ii) determining drag characteristics for the first shape;
(iii) generating a new shape;
(iv) determining drag characteristics for the new shape;
(v) comparing the drag characteristics of the current best shape and the drag characteristics of the new shape to identify which shape has superior drag characteristics;
(vi) designating either the current best shape or the new shape as the current best shape;
(vii) repeating steps (iii)-(vi) until a threshold condition is met; and
(viii) once the threshold condition has been met, designating the current best shape as the optimal drag-reducing structure shape.

In step (i), generating the first shape may comprise randomly generating a shape. The shape may be randomly generated subject to constraints imposed by the working parameters. Working parameters may impose shape volume restrictions. Working parameters may impose the maximum size of the structure in each dimension. Working parameters may impose the maximum size of the structure in each dimension such that the structure is configured to fit on the front deck of a cargo ship. The shape may be randomly generated with a predetermined size. The shape may be randomly generated with a predetermined volume.

The algorithm may always generate the same first shape. The algorithm may always generate the same first shape for a given vehicle. The first shape may be a regular sphere or cuboid. The first shape may be a regular sphere or cuboid with predefined dimensions. The first shape may be generated based on a template shape which is adjusted based on the working parameters.

In steps (ii) and (iv), determining drag characteristics may comprise modelling the vehicle, together with a drag-reducing structure having the shape to be tested, and performing airflow simulations. In steps (ii) and (iv), determining drag characteristics may comprise modelling a cargo ship and drag-reducing structure having the shape to be tested positioned on the front deck of the cargo ship, and performing airflow simulations. Results may be obtained based on the airflow simulations, such as the overall drag force exerted on the vehicle under various conditions, and the drag co-efficient of the vehicle.

The drag characteristics may comprise a pressure map. The pressure map may indicate the pressure exerted on the shape at each point across the surface of the shape during airflow simulations. The pressure map may comprise isobar lines. The drag characteristics may comprise the pressure gradient at each point across the surface of the shape during airflow simulations.

In step (iii), the new shape may be generated by modifying the current best shape. The new shape may be generated by modifying the current best shape based on the drag characteristics of the current best shape.

The new shape may be generated by modifying the current best shape to reduce the size of, or remove, regions of the current best shape. The new shape may be generated by modifying the current best shape to reduce the size of, or remove, the regions which experience high pressure during simulations in step (ii). The new shape may be generated by modifying the current best shape to increase the size of the regions which experience low pressure during simulations in step (ii).

The pressure map for the current best shape generated during step (ii) may be used to generate the new shape. The pressure gradient across the surface of the shape for the current best shape generated during step (ii) may be used to generate the new shape. Gradient descent algorithms may be used to identify local pressure maxima. Gradient descent algorithms may be used to identify local pressure minima. The new shape may be generated by adjusting the sections of the shape corresponding the local pressure maxima to reduce the pressure exerted on that section of the shape. The new shape may be generated by adjusting the sections of the shape corresponding the local pressure minima to increase the pressure exerted on that section of the shape.

In step (iii), the new shape may be generated subject to constraints imposed by the working conditions. Constraints imposed for the new shape may be identical to constraints imposed by the working parameters when generating the starting shape. The new shape may be generated subject to the constraint the volume of the shape must increase relative to the current best shape. The new shape may be generated subject to the constraint the volume of the shape must not decrease relative to the current best shape.

Modifying the current best shape based on the drag characteristics increases the likelihood that the newly generated shape has superior drag characteristics compared with the current best shape.

The “superior drag characteristics” may be determined according to a pre-determined set of rules. The shape which provides the lowest overall drag for a vehicle may be designated as having the superior drag characteristics. The shape which produces a lower drag co-efficient during simulations may have the superior drag characteristics.

The shape which produces a lower average drag co-efficient during simulations may have the superior drag characteristics.

The shape with the superior drag characteristics may be designated as the current best shape. If the new shape does not have the superior drag characteristics, it may be randomly designated as the new best current shape with a predetermined chance. If the new shape does not have the superior drag characteristics, it may be randomly designated as the new best current shape with a 50% chance. If the new shape does not have the superior drag characteristics, it may be randomly designated as the new current best shape with a less than 50% chance. If the current best shape has the superior drag characteristics, it may be maintained as the new current best shape.

Replacing the current best shape with a new shape when the new shape has superior drag characteristics ensures that the drag characteristics improve as the algorithm continues. Allowing a shape with worse drag characteristics to be randomly selected as the best current shape prevents the shape being optimised to a local drag co-efficient minimum, rather than a global drag co-efficient minimum.

In step (vii), the threshold condition may be that the current best shape has remained unchanged for after a certain number of repetitions of steps (iii)-(vi). The threshold condition may be that no reduction in drag co-efficient has been achieved exceeding x % in the previous n repetitions of steps (iii)-(vi) (n and x % are values which can be altered depending on the circumstances).

Forming the drag-reducing structure may comprise:
forming a support structure; and
applying a surface cover to the support structure.

Forming the support structure may comprise generating a support structure design. Forming the support structure may comprise generating a support structure design based on the working parameters. Forming the support structure may comprise building the support structure based on the support structure design.

Forming the support structure may comprise generating a support structure design using generative design algorithms. Generative design algorithms, such as those found in PTC Creo, or Autodesk 360 fusion, may be used to generate the support structure design based on the working parameters. Generative design algorithms may be used to generate the support structure design subject to constraints imposed by the working parameters.

The working parameters may impose constraints which limit the total weight of the support structure design. The working parameters may impose constraints which limit the dimensions of the support structure design. The working parameters may impose constraints which limit the positions of the support structure design. The working parameters may impose constraints which limit the complexity of the support structure.

The working parameters may impose constraints which ensure the support structure is configured to support a given weight. The given weight may be the weight of the surface cover. The given weight may be the weight of the surface cover plus any forces imparted by airflow over the surface cover. The given weight may be the weight of the surface cover plus any forces imparted by airflow over the surface cover and external forces exerted on the surface cover. External forces may be exerted on the surface cover by oceanic waves. The working parameters may impose constraints which prevent the support structure from restricting access from areas of the vehicle, such as the whole of, or sections of, the front deck of a cargo ship.

Generating a support structure using generative design algorithms may comprise modelling the drag reducing structure as a solid block. The solid block may have the ideal drag-reducing structure shape. The surface of the solid block may be modelled with properties of the surface cover. The surface of the solid block may be modelled as having the same weight as the surface cover. The surface of the solid block may be modelled as having the same thickness as the surface cover. Generative design algorithms may remove material from the inside of the solid block to generate the support structure design. A finite element analysis (FEA) may be conducted to whether stress levels and structural deformation under load are within specifications.

Applying a surface cover to the support structure may comprise attaching a surface cover to the support structure. Applying a surface cover to the support structure may comprise forming the surface cover directly on the support structure. The surface cover may be applied to cover the entire surface area of the support structure. The surface cover may be applied to cover a part of the surface area of the support structure.

The support structure may comprise one or more inflatable structures and a structural frame. Forming the drag-reducing structure may comprise connecting the one or more inflatable structures to the support frame. Forming the drag-reducing structure may comprise covering the one or more inflatable structures with a surface cover. Forming the drag-reducing structure may comprise covering the one or more inflatable structures with a shell. Forming the drag-reducing structure may comprise covering the one or more inflatable structures with a polymeric shell.

Using inflatable structures reduces the assembly time of the support structure and reduces the overall assembly time of the drag-reducing structure.

Forming the drag-reducing structure may comprise applying one or more metal sheets to the support structure. Applying one or more metal sheets to the support structure may comprise bolting one or more metal sheets to the support structure. Applying one or more metal sheets to the support structure may comprise sticking the one or more metal sheets to the support structure via an adhesive.

Forming the drag-reducing structure may comprise covering the support structure with pre-stressed/pre-tensioned polymeric fabric. Covering the support structure with pre-stressed/pre-tensioned polymeric fabric may comprise connecting one or more edges of the pre-stressed polymeric fabric to the support structure.

Forming the drag-reducing structure may comprise forming the drag-reducing structure directly onto the vehicle. The drag-reducing structure may be retrofit to existing vehicles. The drag-reducing structure may be retrofit to existing cargo ships.

The support structure may be built on the vehicle and attached to the vehicle. The surface cover may then be applied to the support structure to form the drag-reducing structure directly on the ship.

According to a second aspect of the invention, there is provided a structure for reducing drag force exerted on a vehicle. The structure may be a drag-reducing structure. The structure may comprise a support structure and a surface cover.

The structure may be formed using the method of the first aspect of the invention. The structure may be the drag-reducing structure formed using the method of the first aspect of the invention. The support structure may be the support structure discussed in the context of the first aspect of the invention. The surface cover may be the surface cover discussed in the context of the first aspect of the invention.

The structure may be configured to reduce drag exerted on a vehicle by redirecting airflow around the structure and the vehicle. The structure may be configured to ensure airflow remains substantially laminar as it passes over the structure and around the vehicle. The structure may be configured to redirect airflow around the vehicle to reduce/prevent turbulent airflow. The structure may be configured to redirect airflow over the top of shipping containers on a cargo ship.

The surface cover may be formed from, or comprise, a material which air cannot pass through. The surface cover may be formed from, or comprise, a material which is configured to deflect airflow around a vehicle. The surface cover may redirect airflow according to the shape of the structure.

The surface cover may be formed from, or comprise, a weather-resistance material. The surface cover may be formed from, or comprise, a wind, rain, and/or sun-resistance material. The surface cover may be formed from, or comprise, a salt-resistance material. The surface cover may be formed from, or comprise, any material configured to withstand repeated and/or prolonged exposure to varying weather conditions and high-speed winds.

The support structure may be attachable to the vehicle. The support structure may be configured to fit on a portion on the vehicle. The support structure may have dimensions such that it can fit on a portion of the vehicle. The support structure may have dimensions which enable it fit on the front deck of a cargo ship. The support structure may be attachable to the vehicle using one or more tensions cables, one or more clamps, one or more bolts, or one or more weights.

The support structure may be connected to the surface cover. The support structure may be permanently connected to the surface cover. The support structure may be reversibly connected to the surface cover. The support structure may be connected to the surface cover via one or more bolts. The support structure may be connected to the surface cover via one or more tension cables. The support structure may be connected to the surface cover via welding.

The support structure may be connected to the surface cover to provide and maintain a structure shape. The structure shape may be configured to reduce drag forces exerted on the vehicle. The structure shape may be substantially identical to an optimal drag-reducing structure shape. The structure shape may be configured to redirect airflow around the vehicle to avoid regions which generate turbulent airflow. The structure shape may be configured to redirect airflow over the top of shipping containers on a cargo ship.

The support structure may comprise one or more inflatable structures. The support structure may comprise a support frame. The support structure may comprise one or more inflatable structures and a support frame. The one or more inflatable structures may connect to the support frame. The one or more inflatable structures may be stacked upon each other and fixed in position by the support frame. The support frame may be a gantry. The support frame may comprise a plurality of gantries.

At least one of the one or more inflatable structures may be an inflatable rib. At least one of the inflatable structures may be formed from, or comprise, a fabric. At least one of the inflatable structures may be formed from, or comprise, a polyester fabric.

At least one of the inflatable structures may be formed from, or comprise, a PVC-coated polyester fabric.

The use of inflatable structures reduces the time required to assemble and disassemble the drag-reducing structure. The inflatable-based support structure provides a lightweight support structure which does not restrict access to the area beneath the support structure.

The inflatable structures may be connected to an air compressor configured to maintain a desired pressure within the inflatable structures. The inflatable structures may be connected to a pressure sensor which controls the air compressor to maintain a desired air pressure inside the inflatable structures.

The surface cover may be, or comprise, a shell. The surface cover may be, or comprise, a polymeric shell. The shell may be flexible. The shell may be configured to cover the support structure. The shell may be configured to cover the entire surface of the support structure. The shell may be configured to cover at least a portion of the surface of the support structure.

The polymer shell may be formed from, or comprise, Hypalon. The polymer shell may be formed from, or comprise, Low-density polyethylene (LDPE), High-density polyethylene (HDPE), Polypropylene (PP), Polyvinyl chloride (PVC), Polystyrene (PS), Nylon, nylon 6, nylon 6.6, Teflon (Polytetrafluoroethylene), or Kevlar.

The support structure may comprise a wireframe. The surface cover may be attached to the wireframe.

A wireframe support structure enables the drag-reducing structure to retain its shape by supporting the surface cover, whilst being lightweight and using fewer materials/resources.

The surface cover may comprise one or more sheets/panels. The surface cover may comprise one or more metallic sheets. The surface cover may comprise one or more steel sheets. The surface cover may comprise one or more Corten steel sheets. The one or more sheets may be attach to the wireframe support structure.

Using metals, such as Corten steel, ensures the drag-reducing structure is resilient and has low maintenance costs. Corten steel ensures that drag-reducing structures in resistant to water, salt, sunlight, wind, and other weather conditions.

The surface cover may be, or comprise, a fabric. The surface cover may be, or comprise, a pre-stressed fabric. The surface cover may be, or comprise, a polymeric fabric. The surface cover may be, or comprise, a pre-stressed polymeric fabric. Using a pre-stressed polymeric fabric ensures the drag-reducing structure is lightweight, and it enables a less complex support structure to be used.

The support structure may be configured to allow access to desired areas of the vehicle. Desired areas of a vehicle may be areas which passengers of the vehicle need unrestricted access to. The desired areas of the vehicle may the positions of ship machinery on a front deck of a cargo ship.

The vehicle may be a cargo ship. The structure may be configured to fit on the front deck of the cargo ship.

The shape of the structure may be adjustable. The structure may be adjustable via a system of levers, pulleys, and tensioned cables. The structure may be adjustable via hydraulic pistons.

The support structure may be adjustable to adjust the shape of the drag-reducing structure. The support structure may comprise one or more folding sections which enable height adjustment. For support structures comprising one or more inflatable structures, one or more of the inflatable structures may be inflated, deflated, partially inflated, or partially deflated to adjust the height of the support structure.

The support structure may comprise a height adjustable gantry. The support structure may comprise a plurality of height adjustable gantries. A gantry may refer to a horizontal bar suspended by two vertical pillars, wherein the height of the horizontal bar is adjustable. The gantry may be adjustable using pulleys and cables, hydraulic pistons, gears, and/or any other suitable means. The gantries may be formed from, or comprise, one or more metals such as steel.

The structure may be configured to adjust its shape automatically. The structure may comprise one or more sensors. The structure may be configured to adjust its shape in response to signals received from the sensors.

The structure may be configured to automatically adjust its height. The structure may be configured to adjust its height in response to signals received from the sensors. The sensors may be configured to determine the height of cargo being transported by a vehicle. The sensors may be configured to determine the height of shipping containers being transported by a cargo ship. The sensors may be configured to determine the combined height of stacked shipping containers being transported by a cargo ship. The structure may be configured to adjust its height automatically to match the height of the cargo being transported. The structure may be configured to adjust its height automatically to match the height of the shipping containers.

According to a third aspect of the invention, there is provided a computer-implemented method for generating an optimal drag-reducing structure shape. The method may be a method for generating an optimal drag-reducing shape configured to reduce drag force exerted on a vehicle. The method may be a method for generating an optimal drag-reducing shape configured to reduce drag force exerted on a cargo ship.

The method may comprise generating a drag-reducing structure design by generating an optimal drag-reducing structure shape. The method may comprise generating a support structure design.

The method may comprise providing one or more working parameters. The method may comprise generating, based on the one or more working parameters, an optimal drag-reducing structure shape.

The method may comprise generating a support structure design. The method may comprise generating a support structure design based on the one or more working parameters. The method may comprise generating a support structure design which, in use, is configured to support a drag-reducing structure to maintain the shape of the drag-reducing structure. The method may comprise generating a support structure using generative design algorithms.

The method may comprise any of the steps recited in the method of the first aspect of the invention. The method may generate a design for the structure of the second aspect of the invention.

According to a fourth aspect of the invention, there is provided an algorithm for generating an optimal drag-reducing structure shape. The algorithm may be the algorithm defined in accordance with the first aspect of the invention.

According to a fifth aspect of the invention, there is provided one or more computer-readable storage media.

The one or more computer-readable storage media may comprise instructions that, when executed by a processor, cause the processor to calculate how to reduce drag forces exerted on a vehicle. The one or more computer-readable storage media may comprise instructions that, when executed by a processor, cause the processor to perform the method in accordance with the third aspect of the invention.

The one or more computer-readable storage media may comprise instructions that, when executed by a processor, cause the processor to perform an algorithm to generate an optimal drag-reducing structure shape. The one or more computer-readable storage media may comprise instructions that, when executed by a processor, cause the processor to perform the algorithm in accordance with the fourth aspect of the invention.

Optional features of any of the above aspects may be combined with the features of any other aspect, in any combination. For example, features described in connection with the method of the first aspect may have corresponding features definable with respect to the structure of the second aspect, and vice versa, and these embodiments are specifically envisaged. Features which are described in the context or separate aspects and embodiments of the invention may be used together and/or be interchangeable wherever possible. Similarly, where features are, for brevity, described in the context of a single embodiment, those features may also be provided separately or in any suitable sub-combination.

### BRIEF DESCRIPTION OF THE DRAWINGS

The invention will now be described, by way of example only, with reference to the accompanying drawings, in which:

FIGS. 1(a) and (b) show side and perspective views respectively of a cargo ship with a drag-reducing structure installed;

FIGS. 2(a) and (b) respectively show simplified side views of cargo ships with and without a drag-reducing structure installed;

FIG. 3 shows an overview of a method for reducing drag on a vehicle;

FIGS. 4(a) and (b) show plan views of the front deck of a cargo ship.

FIG. 5 shows an algorithm for generating an optimal drag-reducing structure shape;

FIG. 6 shows a plurality of shapes generated by algorithm in the process of obtaining the optimal drag-reducing shape.

FIG. 7 shows a section of an algorithm for generating an optimal drag-reducing structure shape;

FIG. 8 shows exploded and assembled views of a drag-reducing structure;

FIG. 9 shows a drag-reducing structure with a support structure comprising a plurality of sub ribs;

FIGS. 10(a) and (b) respectively show perspective and back views of adjustable drag-reducing structures;

FIG. 11 shows a perspective view of another drag-reducing structure;

FIG. 12 shows a perspective view of another drag-reducing structure;

FIGS. 13(a) and (b) respectively show perspective and back views of adjustable drag-reducing structures;

FIG. 14 shows a perspective view of a drag-reducing structure comprising two distinct sections made from different materials;

FIGS. 15(a)-(c) show views of an alternative adjustable drag-reducing structure;

FIG. 16 shows a perspective view of a further alternative drag-reducing structure;

FIGS. 17a-c show front and perspective views of a ship with a drag reducing structure disposed thereon; and

FIGS. 18(a) and (b) show perspective views of a ship having a mounting frame, with and without a drag reducing structure installed respectively.

### DETAILED DESCRIPTION

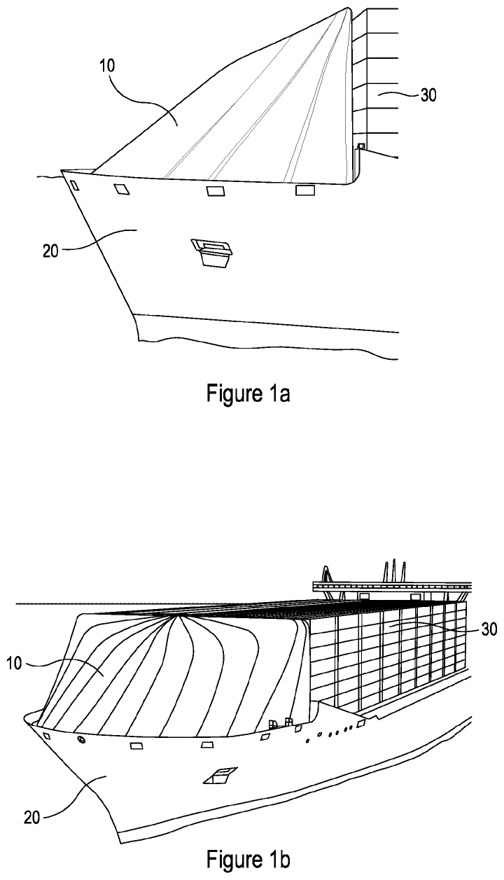

FIGS. 1a and 1b show side and perspective views of a cargo ship 20 transporting shipping containers 30. A drag-reducing structure 10 is positioned on the front deck of the ship 20, ahead of the containers in the direction of travel of the cargo ship 20. The drag-reducing structure is configured to reduce the turbulent airflow around the front of the ship 20 to reduce the drag force exerted on the ship 20.

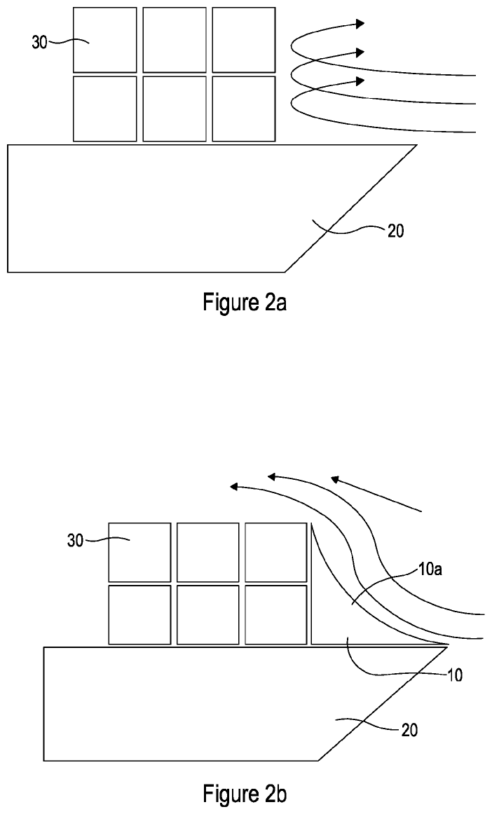

FIG. 2a shows a simplified side view of the ship 20 loaded with containers 30 without a drag-reducing structure 10. FIG. 2b shows a simplified side view of the ship 20 loaded with containers 30, and with the drag-reducing structure 10 installed. These figures demonstrate how the drag-reducing structure 10 influences airflow around the ship 20 as the ship 20 travels in a direction from left to right.

In FIG. 2a, the ship 20 does not have a drag-reducing structure. Air flowing directly towards the front of the ship 20 hits the vertical sides of the containers 30 to create areas of turbulent airflow and recirculation. The turbulent airflow and recirculation increase the drag force exerted on the ship 20.

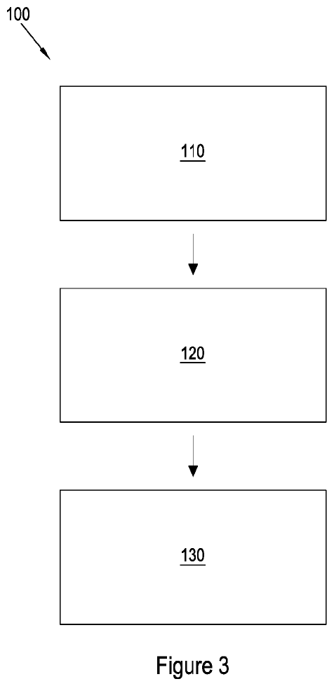

FIG. 2b shows an identical ship 20 to FIG. 3a, but with a drag-reducing structure 10 on the front deck of the ship 20. Air flowing towards the front of the ship 20 hits a front surface 10a of the drag-reducing structure 10, instead of the vertical sides of the containers 30. The drag-reducing structure 10 provides a gradient or graduated surface leading up from the deck of the ship 20 to, or towards, the top of the containers 30. The drag-reducing structure 10 enables air to change direction gradually, or more gradually, than the vertical container 30 walls and avoids the airflow hitting a vertical wall. The drag-reducing structure 10 promotes laminar airflow up and over the top of the containers 30. The drag-reducing structure 10 reduces the level of turbulent flow.

FIG. 3 shows an overview of a method 100 used to produce a drag-reducing structure which reduces turbulent airflow at the front of the vehicle. In some examples, the method can be used to reduce the drag forces exerted on a ship, such as a cargo ship.

The method comprises the steps of:
providing 110 one or more working parameters;
generating 120, based on the one or more working parameters, a drag-reducing structure shape; and
forming 130 a drag-reducing structure based on the drag-reducing structure shape.

The working parameters provided in step 110 depend on the application and on the desired use of the vehicle. For example, when the vehicle is a cargo ship, example working parameters are one or more of: average cruising speed, maximum cruising speed, maximum load capacity, average load capacity, front deck shape, front deck layout, front deck size, ship size, ship shape, front deck size, and the position of equipment on the ship.

In other examples, the method can be used to reduce the drag forces exerted on another type of vehicle, such as a lorry/truck. In such examples, example working parameters are one or more of: lorry/truck type (i.e., make and model), average speed, container size, and container shape.

The working parameters are used in the step of generating 120 a drag-reducing structure shape, preferably to optimise airflow and minimise turbulence. For example, when using the method 100 to reduce the drag forces exerted on a ship, the size and layout of the front deck of the ship needs to be considered when generating the drag-reducing structure shape. In such examples, the front deck layout may be modelled using a drone and photogrammetry process.

The shape and size of the both the ship 20 and the shipping containers 30 are working parameters that are considered when using method 100 to reduce the drag forces exerted on a cargo ship 20. Taking these working parameters into consideration enables the generation 120 of a drag-reducing structure shape which is optimised to reduce the drag forces for a specific ship carrying specific containers. This enables the generation 120 of bespoke, and in some examples, optimal, drag-reducing structure shapes optimised for specific situations.

Taking the front deck layout and size (which are other working parameters) into account when generating the drag-reducing structure shape ensures that the drag-reducing structure shape fits on the ship as intended, and that the ship's crew members are still able to access relevant parts of the front deck.

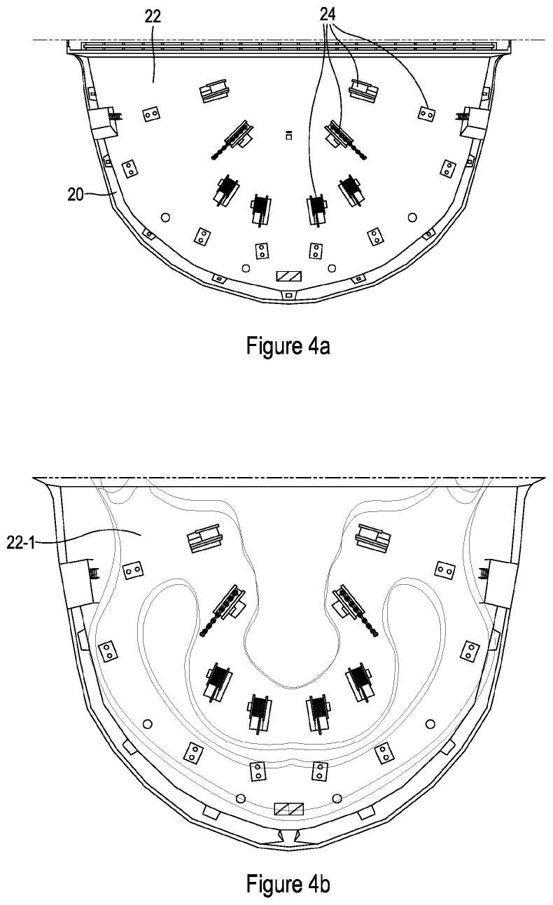

FIG. 4a shows a plan view of the front deck 22 of a ship 20. Various pieces of equipment and machinery 24 are positioned on the front deck 22 of the ship 20. When the ship 20 is sailing, it is imperative that crew members are able to access the machinery 24 on the front deck 22. As shown in FIG. 4b, the front deck 22 defines an accessible region 22-1. The accessible region 22-1 is defined to include all the machinery 24 to which crew members require unrestricted access.

To provide the required unrestricted access, the accessible region 22-1 of the front deck 22 of the ship 20 is used as a working parameter when generating 120 the drag-reducing structure shape. This ensures that the drag-reducing structure shape is generated subject to the constraint that crew members need access to the accessible region 22-1.

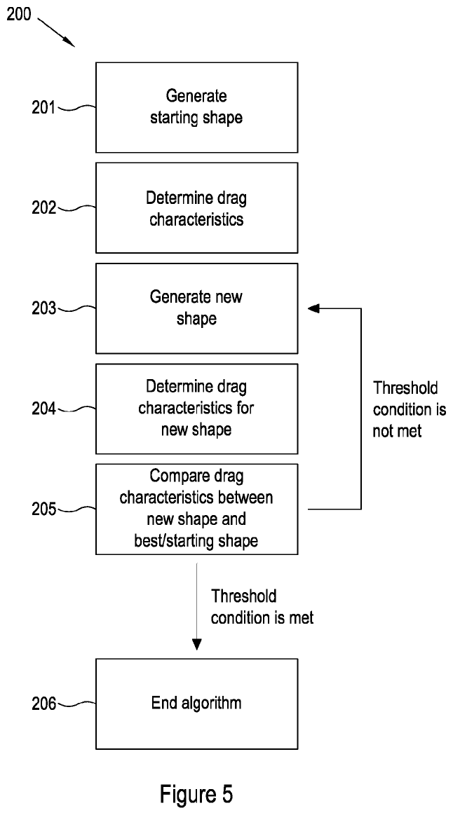

FIG. 5 shows an overview of an example algorithm 200 used to generate the drag-reducing structure shape. The algorithm 200 is configured to produce a drag-reducing structure shape optimised to reduce drag forces exerted on a vehicle.

Algorithm 200 is executed on one or more processors (e.g., on a computer). In some examples, a user provides working parameters for use in the algorithm through conventional input means. A user may use a keyboard and/or mouse to input working parameters to the processor.

In some examples, one or more working parameters associated with a vehicle type are available to one or more processors, and a user simply provides an input to indicate the relevant vehicle type. In some examples, the one or more processors access working parameters which are pre-stored in a memory connected to the one or more processors. In other examples, working parameters are obtained form an external server, for example, through the internet.

The first step 201 of algorithm 200 is generating a first shape (also referred to as a “starting shape”). In some examples, the position of the shape on the vehicle is generated as well generating the shape itself. In other examples, the position of the shape on the vehicle is provided as a working parameter.

In some examples, the first step 201 always generates the same starting shape. In other examples, the first step 201 always generates a starting shape from a set of predetermined possible starting shapes and/or based on input parameters. In other examples, the first step 201 generates a randomised starting shape, such as a randomly generated ellipsoid.

The starting shape is generated subject to the constraints implied by the working parameters. For example, for a cargo ship, the generated starting shape must be positioned on front deck, and the shape must not be too large. For example, for a cargo ship, the starting shape is generated subject to the constraint that the dimensions of the shape must not exceed the dimensions of the front deck, such that a drag-reducing structure having that shape would fit on the front deck of the ship. The generated starting shape must not touch or intersect the outer perimeter of the front deck but must be large enough to provide the required reduction in drag when in use.

The “current best shape” is the shape which has provided the best drag characteristics of all the shapes which have been generated. The shape generated in step 201 is, in examples, designated as the “current best shape”. This is because it is the first shape, and no alternative shapes have been generated at this stage.

Step 202 of algorithm 200 is to determine drag characteristics for the current best shape (which may be the starting shape). Determining the drag characteristics for a shape comprises analysing drag co-efficients for the vehicle when a drag-reducing structure having that shape is positioned on the vehicle. For example, for a cargo ship, determining the drag characteristics comprises determining the drag co-efficients of the ship with the optimal drag-reducing structure formed on its front deck. In step 202, a pressure map may be generated indicating the air pressure exerted on and across the surface of the shape.

Drag characteristics are determined by modelling the vehicle, together with a drag-reducing structure having the shape to be tested and performing airflow simulations. In an example, determining drag characteristics comprises running a drag coefficient analysis using specialised computer software, such as OpenFOAM. When using OpenFOAM, running a drag co-efficient analysis is a standard process which uses the function “forceCoeffs”. In other examples, any other suitable airflow simulation software can be used. For example, SimScale can be used to determine the drag characteristics for a shape. In other examples Ansys can be used to determine the drag characteristics for a shape. Other example software packages include, but are not limited to: Fusion360, solidworks, Autodesk CFD, Paraview, and Simulia. The vehicles and drag-reducing structures can be modelled using any suitable computer-aided design (CAD) software or can be modelled directly in the airflow simulation software.

Step 203 of algorithm 200 is generating a new shape. The new shape is different to the current best shape.

The current best shape is used to generate the new shape. For example, a random change may be applied to the first/starting shape to create the new shape. The random change could include one or more of: changing the shape size, adding sections to the shape, removing sections from the shape, or changing the size of a section of the shape.

The new shape may be generated from the current best shape based on the drag characteristics of the current best shape. In some examples, the pressure distribution (calculated during step 202) on the surface of the current best shape is used to generate the new shape.

For example, the current best shape may be modified to reduce the size of the zones with high pressures. For a cargo ship, the pressure distribution around the current best shape may be generated during step 202, and parts of the current best shape which are subject to high pressure may be removed or reduced in size (except at the very front of the ship, where a high-pressure zone is expected).

In some examples, the new shapes are generated by modifying the current best shape to modify areas with high pressures and/or low pressures. Regions of high pressure and regions of low pressure both disturb the laminar flow of air to induce drag a force on a vehicle.

High pressure regions are usually caused by an obstacle (i.e., part of the structure) blocking the airflow path. If a section of the structure is subject to high pressure airflow during simulations/tests/analysis performed in step 202, it can be removed, reduced in sized, or modified. The section of the structure subject to the high pressures can be adjusted to reduce the pressure in subsequent simulations.

Low pressure regions are usually caused by a boundary layer separation, meaning the layer of air travelling along the surface of the structure separates from the structure of the surface. Boundary layer separation is usually caused by a sudden shape geometry change. For example, air flowing along the surface of the structure can separate from the surface if there is a sudden dip in the shape. If a section of the shape is shown to be subject to low pressures, the gradient of the shape change in the region may be reduced. For example, the changes on the surface structure can be adjusted to be more gradual.

In some examples, the new shape may be generated based on the current best shape and a pressure map generated for the current best shape during step 202. The pressure map can be used to identify the sections of the shape which are subject to high pressures or low pressures. For example, the areas of high pressure and areas of low pressure can be identified using isobar lines. The pressure map can be used to determine the pressure gradient across the surface of the shape. Gradient descent algorithms, which are well known in the art, may be used to identify local pressure maxima and local pressure minima. In some examples, the sections of the shape where local pressure minimum and maxima occur are adjusted.

The current best shape may be modified according to a predetermined set of rules, or subject to a set of constraints, to generate the new shape. A constraint can be that the overall shape size has to increase—i.e., the shape volume must increase. Another constraint can be that the shape must fit on, or be capable of being formed on, the vehicle (e.g., the shape must be able to fit on the front deck of a cargo ship). In some examples, another constraint is that the shape must be smooth. This constraint would restrict the locations and amplitudes of changes that can be made to the first shape. In some examples, the new shape cannot comprise spikes, fins, or a golf-ball like dimples.

Step 204 of algorithm 200 is determining drag characteristics for the new shape. Step 204 is substantially identical to step 202, but with the new shape generated in step 203 replacing the shape used in step 202. The same type of analysis is performed in steps 202 and 204 (i.e., the same parameter values are calculated).

Step 205 of algorithm 400 comprises comparing the drag characteristics of the current best shape and the new shape to identify which shape has superior drag characteristics. The “superior drag characteristics” may be determined according to a pre-determined set of rules. For example, the shape which provides the lowest overall drag for a vehicle may be identified as having the superior drag characteristics. As another example, the shape with a lower drag co-efficient may have the superior drag characteristics.

Determining the superior drag characteristics may be a two-step process. For example, the drag coefficients for the shapes may be compared to determine which shape provides the lower drag coefficient. If the drag coefficients are sufficiently different (i.e., the drag coefficient of one shape is at least x % less than the other shape), the shape with the lower drag co-efficient is considered to have superior drag characteristics. However, if the drag coefficients are within x % of each other, a more thorough analysis can be used. (The value of x in “x %” may be altered depending on the circumstances. For example, the processing power and time available to perform algorithm 200 may influence the optimal value of x. Example values are 5%, 10% 20% etc.)

For the more thorough analysis required when drag coefficients are within x % of each other, additional simulations are performed. For a given vehicle, a real-world route is identified and the drag characteristics around the vehicle are determined for a simulation in which the vehicle travels through the identified route. The simulated journey may be repeated multiple times using real world meteorological data to simulate real-world conditions.

For example, using a cargo ship, a common shipping route for the ship is determined, and perhaps 5 to 10 trips are simulated with real world meteorological data collected for wind speed and direction. (Fewer than 5 trips, or more than 10 trips, may be simulated depending on the time and processing power available.) To provide realistic trip simulations, the position, orientation, and speed of a cargo ship can be obtained online, using websites such as “marinetraffic.com”. These websites can be used to identify common trips for the ship which the drag-reducing structure is being produced for. The meteorological data may be collected online, using websites such as “power.larc.nasa.gov”. Past meteorological data can be used to ensure the trip simulations are realistic. The drag coefficient is integrated over the simulated trip duration. The simulated journeys are performed for each shape, and the shape which provides the lowest drag coefficient integral is designated as the shape with the superior drag characteristics.

The shape with the superior drag characteristics is then designated as the current best shape. This means that the either the new shape becomes the current best shape, or the current best shape is maintained.

Steps 203-205 are repeated until a threshold condition is met. When the threshold condition is met, the current best shape is designated as the optimal drag-reducing structure shape and the algorithm ends.

The threshold condition may be that the current best shape has remained unchanged for after a certain number of repetitions. For example, the threshold condition may be that the current best shape has not changed for five iterations of steps 203-205. The example of five iterations is provided purely as an example, and any other number of iterations may equally be used.

Another example threshold condition may be that no reduction in drag co-efficient has been achieved exceeding x % in the previous n iterations (n and x % are values which can be altered depending on the circumstances). For example, the threshold condition may be that the drag co-efficient has not decreased by more than 5% in the previous five iterations of steps 203-205.

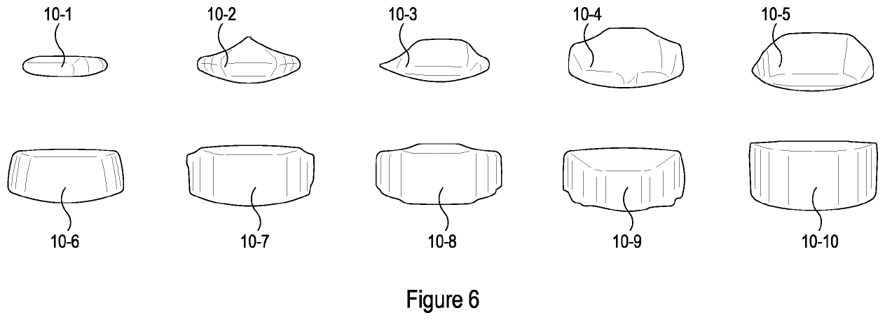

FIG. 6 shows ten shapes, 10-1 to 10-10, generated according to algorithm 200 in an example for a cargo ship. The shapes shown in FIG. 6 are the shapes identified as being the current best shape during the algorithm. Starting from the starting shape 10-1, each shape provides a gradual improvement in drag characteristics over the previous shape, until the shape 10-10 met the threshold condition and was designated as the final/optimal drag-reducing structure shape is obtained.

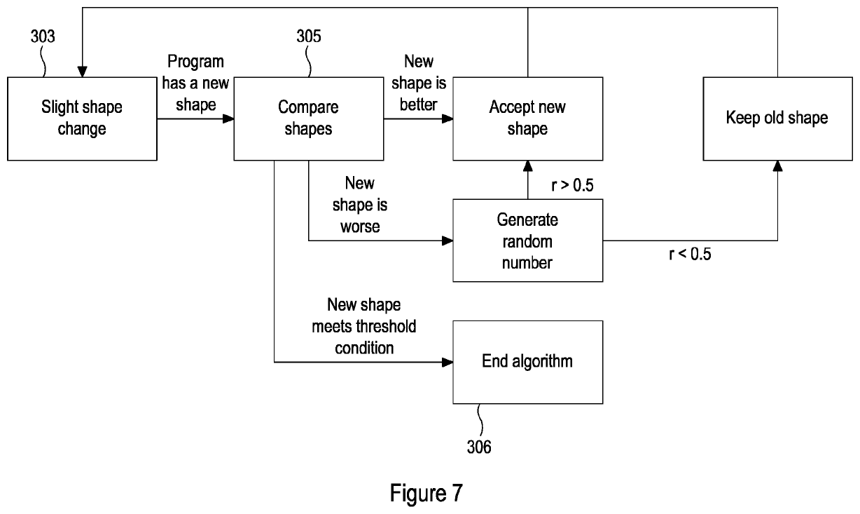

FIG. 7 shows an algorithm 300. Algorithm 300 is part of an algorithm based on the algorithm 200 of FIG. 5. Steps 303, 305 and 306 in algorithm 300 correspond to steps 203, 205 and 206 in algorithm 200.

In algorithm 300, the drag characteristics of the new shape and the current best shape best are compared in step 305. The comparison to determine which shape has superior drag characteristics is the same as in step 205. However, algorithm 300 does not always designate the shape with the superior drag characteristic to be the current best shape, as explained below.

If the new shape generated in step 303 has superior drag characteristics, it is designated as the new current best shape, similarly to in algorithm 200. However, if the new shape has worse drag characteristics, it may still be designated as the new current best shape. If the new shape has worse drag characteristics, a random number, “r”, is generated. If r is greater than a predetermined value, the new shape is designated as the current best shape and, if r is less than the predetermined value, the current best shape is unchanged. In the example of FIG. 6, r is a randomly generated number between 0 and 1, and the predetermined value is 0.5. In other examples, the predetermined value may be changed.

Algorithm 300 allows for a shape with worse drag characteristics to replace a previous shape as the current best shape. Given that the purpose of the algorithms 200, 300 is to provide a shape which minimises drag, this approach prevents algorithm from identifying a shape which provides a local drag co-efficient minimum rather than a global drag co-efficient minimum.

The step of forming 130 a drag-reducing structure based on the (optimal) drag-reducing structure shape in method 100 can be performed in various ways. The drag-reducing structure is formed such that its shape substantially matches the (optimal) drag-reducing structure shape generated in step 120.

Once the (optimal) drag-reducing structure shape is determined (through one of the algorithms 200, 300 or any other means), a support structure of the drag-reducing structure is formed. The support structure is a structure configured to support and maintain the shape of the drag-reducing structure.

The design of the support structure can be computer-generated. The support structure design can be generated subject to one or more of the working parameters. Referring to FIG. 4b, for the example of a cargo ship, the support structure design is generated subject to the constraint that the support structure cannot intercept of block any of the accessible region 22-1. Working parameters can impose further constrains when the support structure design is generated. For example, the size of the support structure can be limited so that it fits on the front deck 22 of a ship 20.

In some examples, the support structure design is generated using artificial intelligence. In some examples, the support structure design is generated using generative design algorithms. In some examples, generative design is used to generate a support structure design subject to the constraints provided by the working parameters. In some examples, generative design algorithms are preformed using Autodesk 360 fusion, or PTC Creo.

To generate a support structure design, The drag-reducing structure is modelled as a solid block having the ideal drag-reducing structure shape. Sections of the modelled drag-reducing structure are modelled as being in contact with a section of the vehicle on which the drag-reducing structure is to be place (i.e., the front deck of a cargo ship). The drag-reducing structure is modelled as only being in contact with the vehicle in specific regions so as to allow access to desired areas of the vehicle (e.g., for a cargo ship, the drag-reducing structure is modelled such that the points of contact between the drag-reducing structure and the front deck of the ship would not prevent crew members from accessing machinery, or regions of the front deck which the crew members require unrestricted access to).

The surface of the drag-reducing structure is modelled having a thickness, density and material properties that mirror reality (i.e., it is modelled with real material properties). The surface of the drag-reducing structure is modelled to have properties corresponding to the material intended to be used for producing a surface cover of the drag-reducing structure. Generative design is used to adjust the interior of the block to provide a support structure design.

Constraints may be imposed on the generative design algorithm. The material of the solid block can be set before the generative design algorithm is executed. The generative design algorithm may be constrained to reduce the volume of the solid block by a given percentage. The generative design algorithm may be constrained to reduce the mass of the solid block by a given percentage. The generative design algorithm may be constrained to maintain the shape of the structure (i.e., the surface geometry cannot be adjusted).

The generative design algorithm may be constrained to ensure that the support structure can support a given weight (i.e., the support structure must not break or change shape when subject to a given weight). The weight which the support structure needs be capable of supporting is the weight of the surface of the drag-reducing structure plus potential frontal and lateral loads/forces corresponding to the wind pressure and any potential impacts from external bodies (e.g., for a cargo ship, the impacts may be from oceanic waves).

The generative design algorithm optimizes the topology (the internal structure of the solid block) to withdraw material where it is not needed. At the end, material is kept only where it is truly needed and thus a support structure design is optimized for supporting the required weight.

To check the support structure design is acceptable, a finite element analysis (FEA) is conducted that checks whether stress levels and structural deformation under load are indeed within specifications. FEA can be performed using the Live Simulation feature in PTC Creo.

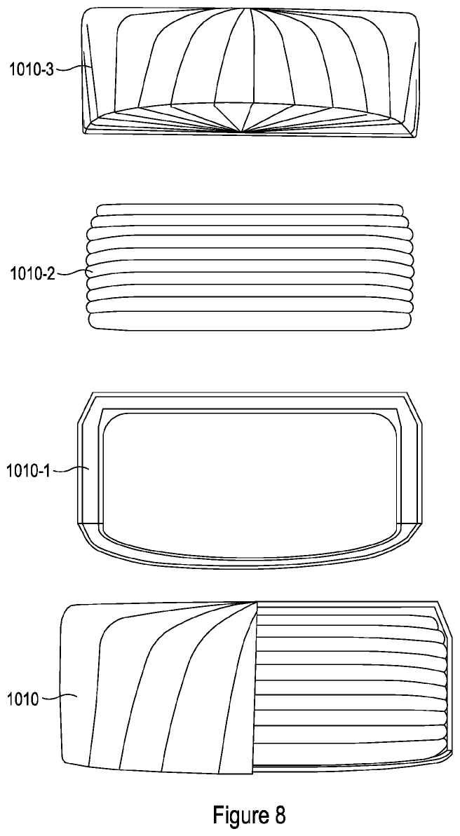

The support structure is formed/manufactured based on the support structure design. After the support structure has been formed, a surface cover is applied over the support structure. Examples drag-reducing structures with various surface covers and support structures are described in greater detail below with reference to FIGS. 8-10.

Although it is desirable to form a drag-reducing structure having the optimal drag-reducing structure shape, this is not always possible and/or feasible. The drag-reducing structure may be formed to have a similar and/or substantially identical shape to the optimal drag-reducing structure shape.

The drag-reducing structure may be formed by assembling a plurality of standardised modular components. A set of standardised modular components may be used to assemble the support structure for every drag-reducing structure. Forming the drag-reducing structure may comprise assembling the standardised modular components to provide a drag-reducing structure which approximates that optimal drag-reducing structure. The drag-reducing structure may be formed by assembling one or more standardised modular components with one or more bespoke modular components made specifically for the vehicle.

Various types of drag-reducing structure can be used. Different types of drag-reducing structure require different support structures. Different types of drag-reducing structure may be more suitable for specific optimal drag-reducing structure shapes.

FIG. 8 shows an inflatable-type drag-reducing structure 1010. FIG. 8 shows each of the constituent components of the drag-reducing structure 1010, as well as the assembled structure. The drag-reducing structure 1010 comprises a support structure comprising a frame 1010-1 and a plurality of inflatable ribs 1010-2. The plurality of inflatable ribs 1010-2 are stacked on top of each other and are held in place via the frame 1010-1.

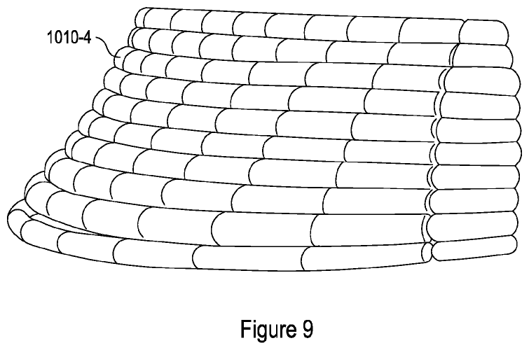

In some examples, the inflatable ribs 1010-2 are subdivided in an alignment of spherical balloons to provide greater resilience. In some examples, the ribs can be subdivided in an alignment of downsized ribs to provide greater resilience. FIG. 9 shows an embodiment in which there are a plurality of inflatable sub ribs 1010-4. Each sub rib 1010-4 has a width less than the width of the frame 1010-1, so multiple columns of stacked sub ribs 1010-4 are required.

The surface cover is a polymer shell 1010-3 which is applied over the support structure to create the drag-reducing structure. The inflatable ribs 1010-2 and/or the polymer shell 1010-3 can be fixed to the frame 1010-3, for example using via tension cables. The polymer shell 1010-3 may slide over the frame 1010-1 and inflatable ribs 1010-2 and be fixed in place. The polymer shell 1010-3 may be fixed in place via bolts, weights, tensioned cables, or other suitable means. The interior volume of the polymer shell 1010-3 may be substantially equal to the volume of the support structure (i.e., the inflatable ribs 1010-2 stacked on the frame 1010-1).

The inflatable ribs 1010-2 and the polymer shell 1010-3 are formed from, or comprise, industrial plastics or polymers which are resistance to sunlight exposure, rain exposure, salt exposure, wind exposure, or exposure to other weather types.

In the example of FIG. 8, the frame 1010-1 is formed from Corten steel. Each of the plurality of inflated ribs 1010-2 are formed from a PVC-coated polyester fabric. The polymer shell 1010-3 is formed from a Neoprene/CSM (Chlorosulfonated Polyethylene) mixture, known as Hypalon. In other embodiments, the polymer shell 1010-3 can be formed from, or comprise, Low-density polyethylene (LDPE), High-density polyethylene (HDPE), Polypropylene (PP), Polyvinyl chloride (PVC), Polystyrene (PS), Nylon, nylon 6, nylon 6.6, Teflon (Polytetrafluoroethylene), Kevlar, or any other suitable polymer.

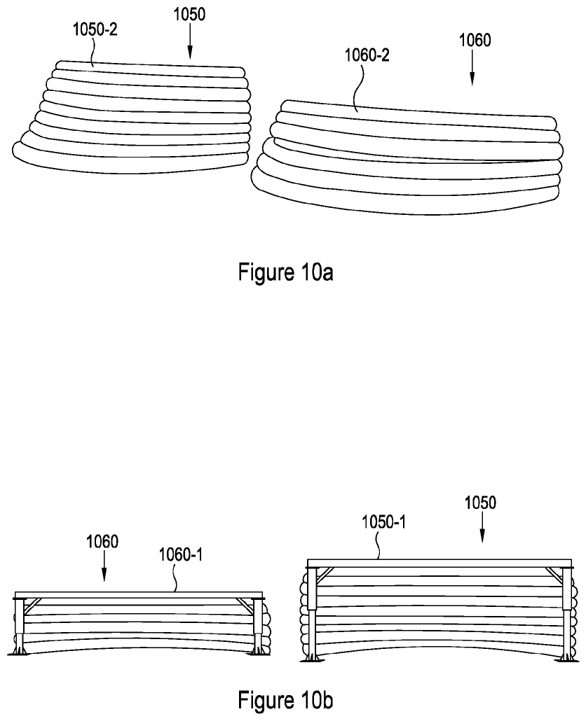

FIGS. 10a and 10b show adjustable drag-reducing structures 1050, 1060 which are similar to the drag reducing structure 1010 of FIG. 8. FIG. 10a shows a perspective view of drag-reducing structures 1050, 1060. FIG. 10b shows a back view of the drag-reducing structures 1050, 1060. For clarity, the drag-reducing structures 1060, 1060 are shown without the polymer shell 1010-3.

The drag reducing structures 1050, 1060 each comprise a support structure comprising inflatable ribs 1050-2, 1060-2 and an adjustable frame 1050-1, 1060-1. The frames 1050-1, 1060-1 are height adjustable gantries. The inflatable ribs 1050-2, 1060-2 are substantially identical to the inflatable ribs 1010-2 of FIG. 8.

The drag reducing structures 1050, 1060 are identical, but the second drag reducing structure 1060 has been adjusted to have a lower height than the first drag-reducing structure 1050.

The first drag reducing structure 1050, on the left of the FIG. 10a (on the right of FIG. 10b), is at maximum height, meaning all inflatable ribs 1050-2 are inflated and the gantry 1050-1 is at its highest position.

The second drag reducing structure 1060, on the right of FIG. 10a (on the left of FIG. 10b), is adjusted to have a decreased height by deflating one of the inflatable ribs 1060-2 and lowering the gantry 1060-1.

In use, the height of the drag-reducing structure 1050, 1060 can be adjusted after installation onto a ship by inflating/deflating one or more ribs 1050-1, 1060-1 and adjusting the height of the gantry accordingly.

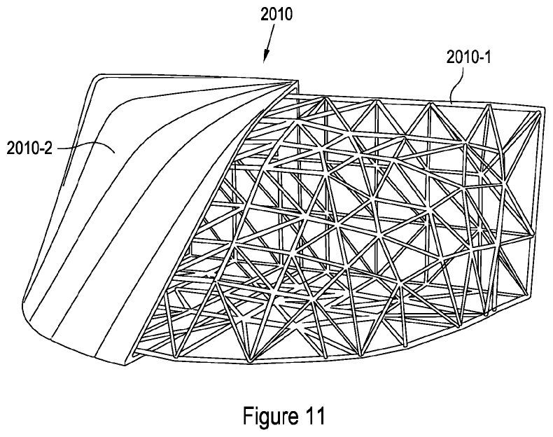

FIG. 11 shows another type of drag-reducing structure 2010. The drag-reducing structure 2010 comprises a support structure 2010-1. The support structure 2010-1 is a metallic wire frame. The support structure 2010-1 was designed using generative design algorithms. The support structure 2010-1 is a steel wire frame. The surface cover is a pre-stressed/pre-tensioned polymer fabric 2010-2 is applied over, and connected to, the support structure 2010-1 to create the drag-reducing structure 2010. The pre-stressed polymer fabric 2010-2 is formed from PTFE. In other examples, the pre-stressed polymer fabric can be formed from, or comprise, Hypalon, or any other suitable polymer fabric. In FIG. 11, a section of the pre-stressed polymer fabric 2010-2 is removed to expose the metallic wire frame support structure 2010-1. In alternative embodiments, the support structure 2010-1 can be replaced with one or more height adjustable gantries, similar to those shown in FIGS. 10a and 10b.

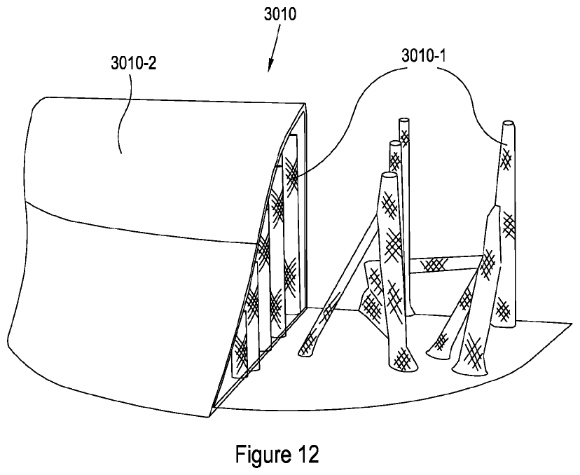

FIG. 12 shows another type of drag reducing structure 3010. The drag-reducing structure 3010 comprises a support structure 3010-1. The support structure 3010-1 design was generated using generative design algorithms. The surface cover 3010-2 is formed from a plurality of metallic sheets/panels 3010-2 which are connected to the support structure 3010-1 to form the drag-reducing structure 3010. In FIG. 12, the metallic sheets 3010-2 are removed from a section of the drag-reducing structure 3010 to expose the support structure 3010-1. In some embodiments, each panel can have a thickness of between 0.5-2.5 cm

In the example of FIG. 12, the metallic sheets 3010-2 are formed from Corten steel. The support structure 3010-1 is also formed from steel. In other embodiments, the support structure is formed from, or comprises, a different metal, such as aluminium.

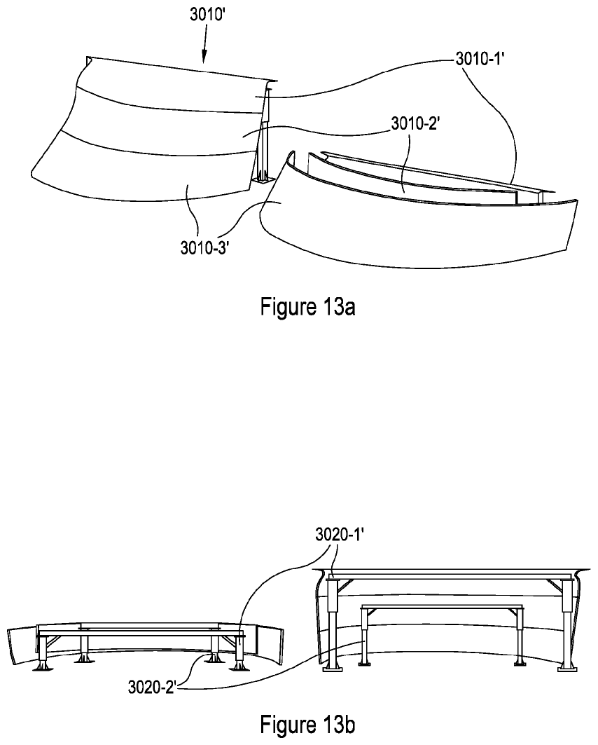

FIG. 13 shows an alternative drag-reducing structure 3010′ which is an adjustable version of the drag reducing structure 3010 of FIG. 12. FIG. 13a shows perspective views of two identical drag-reducing structures 3010′. FIG. 13b shows back views of the drag-reducing structures 3010′.

The support structure comprises two gantries 3020-1′, 3020-2′. The surface cover is divided into three sections 3010-1′, 3010-2′, 3010-3′. Section 3010-1′ is connected to gantry 3020-1′. Section 3010-2′ is connected to gantry 3020-2′. Section 3010-3′ is not connected to a gantry and is disposed on the floor.

The drag-reducing structure 3010′ on the left of FIG. 13a (on the right of FIG. 13b) is at its maximum height. Gantry 3020-1′ is at its maximum height, and gantry 3020-2′ is at a reduced height relative to gantry 3020-1′. The relative positions of the gantries 3020-1′, 2′ are such that each section 3010-1′, 2′, 3′ of the surface cover aligns to form a single continuous sloping surface.

The drag-reducing structure 3010′ on the right of FIG. 13a (on the left of FIG. 13b) is at its minimum height. Both gantries 3020-1′, 2′ are lowered to their lowest possible height such that each section 3010-1′, 2′, 3′ of the surface cover is at the same height. As a result, sections 3010-1′ and 3010-2′ of the surface cover are hidden behind the third section 3010-3′ of the surface cover.

In use, the drag-reducing structure 3010′ can be adjusted to have an overall height anywhere between the maximum and minimum heights by adjusting the gantries accordingly. The various height combinations from the two gantries enables the formation of bespoke structure shapes.

Whilst the surface cover is divided into three sections 3010-1′, 2′, 3′ in FIGS. 13a and 13b, in other embodiments any other number of sections and gantries can be used.

In alternative embodiments, the surface cover can be formed from a plurality of metal panels, each panel being rotatably connected (e.g., via a hinge) to the other panels such that they can be folded to change the overall shape of the drag-reducing structure. The panels can be movable via to hydraulic pistons or motors which are connected via cables, belts or gears.

In another alternative embodiment, the surface cover can be formed from a plurality of metal panels, each panel being slidable such that panels be slid behind other panels so as to reduce the overall shape of the drag reducing structure. The panels can be movable via to hydraulic pistons or motors which are connected via cables, belts or gears.

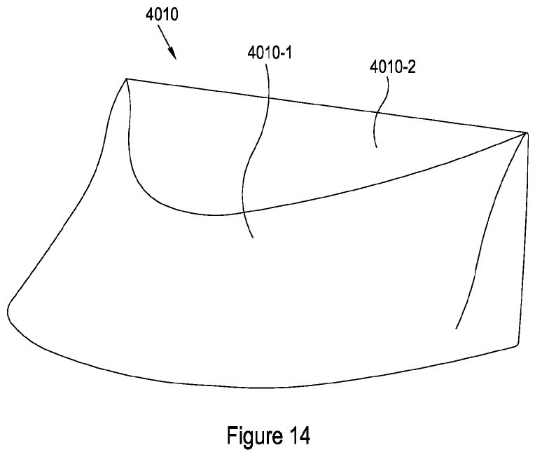

FIG. 14 shows a drag-reducing structure 4010 in accordance with another embodiment. The drag-reducing structure 4010 comprises a lower section 4010-1 and an upper section 4010-2. The lower section 4010-1 comprises a plurality of metallic sheets, similar to those in FIGS. 12 and 13. The upper section 4010-2 can be made from a polymeric material.

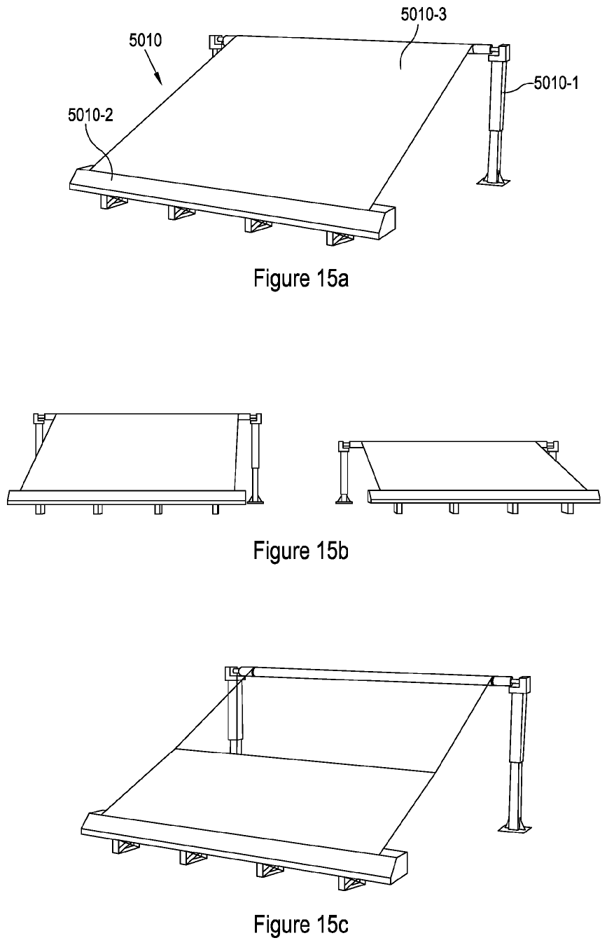

FIG. 15a shows another embodiment of a drag-reducing structure 5010 according to the present invention. The support structure comprises a gantry 5010-1 and a base 5010-2. The surface cover 5010-3 is a roll of fabric 5010-3 suspended between the gantry 5010-1 and the base 5010-2. The roll of fabric can be a polymeric fabric. The roll of fabric can be resistant to UV, salt and other corrosive elements.

The base 5010-2 comprises a spinning roller from which the roll of fabric 5010-3 extends. The spinning roller inside the base 5010-2 maintains tension in the roll of fabric 5010-3.

The drag-reducing structure 5010 is height adjustable, as shown in FIG. 15b. To adjust the height of the structure 5010, the gantry 5010-1 can simply be lowered or raised. The spinning roller enables a greater length of fabric 5010-3 to be rolled out when the gantry 5010-1 is in a higher position, and it spins back to roll up excess fabric to maintain tension in the fabric 5010-3 when the gantry 5010-1 is in a lower position.

FIG. 15c shows a further means by which the drag-reducing structure 5010 is height adjustable. The roll of fabric can be secured part way between the base 5010-2 and the gantry 5010-1. Changing the distance at which the roll of fabric 5010-2 is secured changes the overall height of the drag-reducing structure 5010.

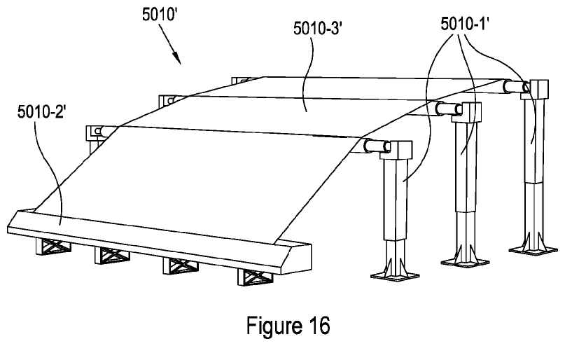

FIG. 16 shows an alternative drag-reducing structure 5010′. The drag-reducing structure 5010′ is similar to the drag-reducing structure 5010 of FIG. 15, but it comprises additional gantries 5010-1″.

The drag-reducing structure 5010′ comprises three gantries 5010-1′. Having additional gantries enables the surface formed by the roll of fabric 5010-3′ to be contoured. This enables the creation of bespoke surface shapes, rather than a simple straight surface between the base 5010-2′ to the gantry 5010-1′ to which the roll of fabric 5010-3′ is connected.

In a further alternative embodiment, each gantry 5010-1′ can be connected to a respective roll of fabric 5010-3′. This would enable the creation of alternative bespoke drag-reducing structure surfaces. Each gantry 5010-1′ other than the end gantries may be connected to two rolls of fabric, such that there is a roll of fabric between each pair of gantries.

The base 5010-2, 5010-2′ in the drag-reducing structures 5010 and 5010′ of FIGS. 15 and 16 can be fitted with a brush to prevent water on the roll of fabric from entering the base. Further, the base can provide 0.5-1 cm holes therein to prevent water from becoming trapped therein. In some embodiments, the base comprises a sensor, such as an optical sensor, for detecting damage to the roll of fabric. Detected damage can be reported to a maintenance team for repair.

The drag-reducing structures 5010 and 5010′ of FIGS. 15 and 16 are shown having open sides. In some embodiments, a shield is provided at the side of the drag-reducing structure to stop wind passing through said sides. Th sides may be permanently attached and may be foldable as a fan-like structure so as to be height adjustable. This can ensure that the sides prevent the passage of wind therethrough regardless of the drag-reducing structure height. The fan-like sides may be made of metal, composite, polymers, fiber or any other suitable material.

In the embodiments above using a roll of fabric, the base can comprise multiple rolls of fabric. Each roll of fabric can be connectable to a gantry. Each roll of fabric can be connectable to a plurality of gantries simultaneously.

In various examples described above, gantries are used to adjust the height of the drag-reducing structure. The height of the gantries described herein can be adjusted using any conventional means, such as through the use of hydraulics, gears, pulleys, and/or cables. In some embodiments, the gantries may be connectable to, and controllable through, an anchor windlass of the ship

In some of the examples described herein, the drag-reducing structure is adjustable. The drag-reducing structure can be adjustable such that the height and/or width of the structure can be adjusted. In examples using a cargo ship, the height of the drag-reducing structure can be adjustable to allow the top of the drag-reducing structure to be made level with the top of the highest shipping container. In some examples, the drag-reducing structure is configured to enable an end user (e.g., a crew on a cargo ship) to adjust the height of the drag-reducing structure.

The drag-reducing structure may be adjusted prior to being fitted onto a vehicle. For example, a drag-reducing structure may be suitable for use with a variety of different cargo ships, and it may be adjusted ready for installation onto a ship. The drag-reducing structure may be adjusted in accordance with forecast data indicating the expected load (e.g., number and height of containers) for a ship which the drag-reducing structure is intended to be installed on. The drag-reducing structure may be adjusted prior to installation based on shipping data from online databases.

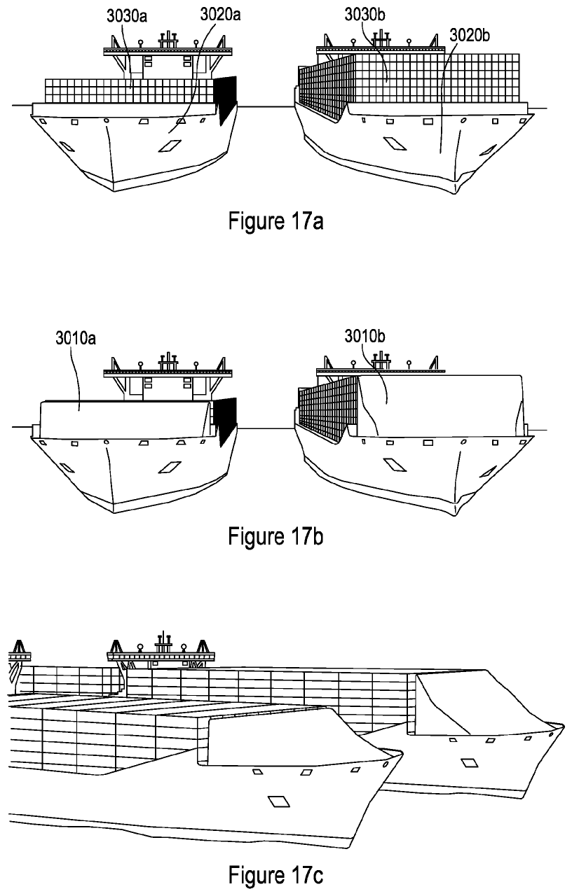

FIG. 17 shows an example of a drag-reducing structure 3030 which is adjustable between a first height and a second height. FIG. 17a shows a first cargo ship 3020a and a second container ship 3020b. Containers 3030a are stacked to a first height on cargo ship 3020a. Containers 3030b are stacked to a second height on cargo ship 3020b. The second height is greater than the first height.

FIG. 17b shows the drag-reducing structure in a first configuration 3010a and the drag-reducing structure in a second configuration 3010b. In the second configuration 3010b, the drag-reducing structure 3010 is taller (i.e., it has a greater height) than in the first configuration 3010a. The drag-reducing structure is adjustable between the first and second configurations. As shown clearly in FIG. 17c, the height of the drag-reducing structure 3010 in the first configuration 3010a matches the height of the containers 3030a. The height of the drag-reducing structure 3010 in the second configuration 3010b matches the height of the containers 3030b. Although only two configurations are shown, a drag-reducing structure may adjustable between any number of configurations, each having a different height. Matching the height of the drag-reducing structure to the height of the containers ensures that airflow is redirected over the top of the containers.

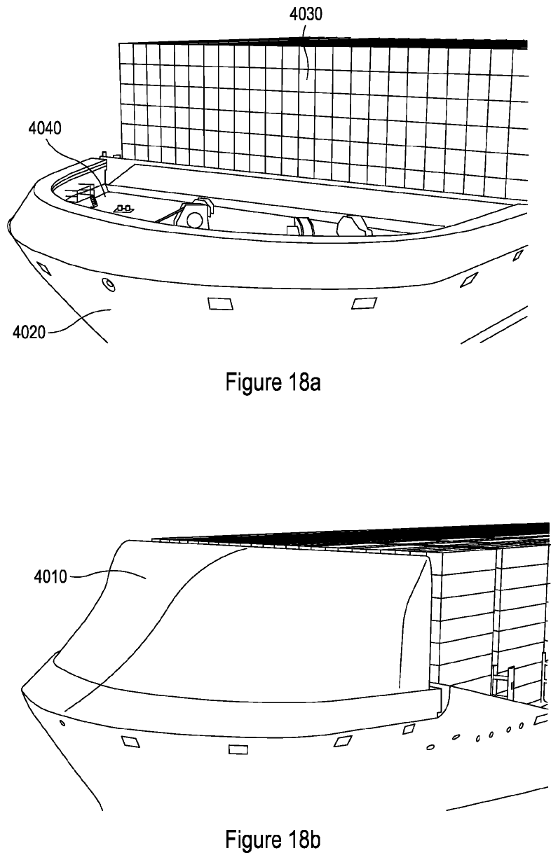

FIGS. 18(a) and (b) show an example of a drag-reducing structure 4010 fitted onto a ship 4020 carrying containers 4030. The ship 4020 is fitted with a mounting frame 4040 which is installed on the ship 4020 prior to the rest of the drag-reducing structure 4010. This mounting frame 4040 holds the drag-reducing structure 4010 in place and allows the structure as a whole to be elevated and lowered, thus ensuring that a crew of the ship 4020 can still access equipment, machinery, and other essential items on the front deck.

In some examples, the drag-reducing adjusts its shape automatically. In some examples, one or more sensors are connected to the structure which determine the height of cargo being transported by the vehicle. In some examples where the vehicle is a cargo ship, the sensors are configured to determine the height of the shipping containers being transported. The structure is configured to adjust its height automatically to match the height of the shipping containers.

For example, for a drag-reducing structure similar to that shown in FIG. 8, the height of the drag-reducing structure can be adjusted by varying the air pressure within the inflatable ribs. In other examples, the height of the drag-reducing container can be adjusted via folding support structures, tensioned cables connected to rotary motors, or hydraulic pistons. In some examples, the drag-reducing structure is configured such that the support structure comprises inflatable ribs which can be deflated and reinflated to adjust the height of the support structure, and pleats are formed in the surface cover, which may be a polymer shell.

In some examples, the drag-reducing structure is configured to be adjustable between a plurality of shapes. In such examples, each of the plurality of shapes is optimised for the vehicle under different working parameters. Each of the shapes may have been generated using algorithm 200 or 300. For example, a drag-reducing structure for a cargo ship may be configured to adjust its height depending on the height of the stacked shipping container (i.e., on the load capacity of the ship).

In some embodiments, the drag-reducing structure may comprise on or more slots or gaps. The slots or gaps may extend from the base of the drag-reducing structure up through the surface cover of the drag-reducing structure. The slots or gaps can be configured to provide a space for other components of the vehicle (e.g., a ship) to fit through. In an example, a drag-reducing structure has a slot configured to enable a radio tower to pass therethrough.

In some embodiments, a bottom surface of the drag-reducing structure may be a solid floor. The floor may be shaped so as to provide a space beneath it, for example, to enable people to fit underneath the floor. For example, when the drag-reducing structure is installed on a ship, the floor may be configured to enable the crew of the ship to pass underneath the drag-reducing structure. The floor may be a metallic floor.

In embodiments wherein the drag-reducing structure fits onto a ship, the drag-reducing structure can be accompanied by a wave protector, which is a metal shield configured to take the impact of incoming waves.

In some embodiments, the drag-reducing structure can comprise one or more vortex generators, such as fins or other protrusions. In some embodiments, the vortex generators can be between 5 and 50 cm in length.

In some embodiments, the surface cover pf the drag-reducing structure comprises a patterned surface (e.g., a dimpled or “golf ball” surface). In some embodiments, the surface cover comprises a plurality of grooves.

From reading the present disclosure, other variations and modifications will be apparent to the skilled person. Such variations and modifications may involve equivalent and other features which are already known in the art of drag-reducing structures and adjustable ship structures, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness. it is also stated that the term “comprising” does not exclude other elements or steps. the term “a” or “an” does not exclude a plurality, a single processor or other unit may fulfil the functions of several means recited in the claims and any reference signs in the claims shall not be construed as limiting the scope of the claims.

1. A structure for reducing drag force exerted on a ship, the structure comprising a support structure and a surface cover, wherein the support structure is connected to the surface cover to provide and maintain a structure shape, wherein the structure shape is configured to reduce drag forces exerted on the ship; and wherein the support structure is adjustable.

2. The structure of claim 1, wherein the support structure is attachable to the ship.

3. The structure of claim 1, wherein the support structure is, or comprises, one or more height adjustable gantries.

4. The structure of claim 1, wherein the support structure is, or comprises, one or more inflatable structures, wherein optionally at least one of the one or more inflatable structures are inflatable ribs formed from, or comprising, a PVC-coated polyester fabric, and the polymer shell is formed from, or comprises, Hypalon.

5. (canceled)

6. The structure of claim 1, wherein the surface cover is, or comprises, a polymeric shell.

7. (canceled)

8. The structure of claim 1, wherein the surface cover is, or comprises, one or more metal sheets, which optionally are, or are formed from, Corten steel.

9. The structure of claim 1, wherein the surface cover is, or comprises, a pre-stressed polymeric fabric.

10. The structure of claim 1, wherein the support structure is configured to allow access to desired areas of the ship and, optionally or preferably, wherein the desired areas of the ship are positions of ship machinery on a front deck of the cargo ship.

11. The structure of claim 1, wherein the structure is configured to fit on the front deck of the ship.

12. A method for forming an adjustable drag-reducing structure for reducing drag forces exerted on a ship, the method comprising:
providing one or more working parameters;
generating, based on the one or more working parameters, an optimal drag-reducing structure shape; and
forming a drag-reducing structure based on the optimal drag-reducing structure shape, wherein the drag-reducing structure is adjustable.

13. The method of claim 12, wherein at least one of the one or more working parameters is: average vehicle speed, maximum ship speed, maximum ship load capacity, or average ship load capacity, ship shape, ship layout, ship size, or the position of equipment/apparatus on the ship.

14. The method of claim 12, wherein generating the optimal drag-reducing structure comprises using an algorithm, the algorithm configured to produce an optimal drag-reducing structure shape optimised to reduce drag forces experienced by the ship.

15. The method of claim 14, wherein the algorithm is configured to determine the optimal drag-reducing structure shape by:
(i) generating a first shape and designating it as the current best shape;
(ii) determining drag characteristics for the first shape;
(iii) generating a new shape;
(iv) determining drag characteristics for the new shape;
(v) comparing the drag characteristics of the current best shape and the drag characteristics of the new shape to identify which shape has superior drag characteristics;
(vi) designating either the current best, or the new shape, as the current best shape;
(vii) repeating steps (iii)-(vi) until a threshold condition is met; and
(viii) once the threshold condition has been met, designating the current best shape as the optimal drag-reducing structure shape.

16. The method of claim 15 wherein, in step (vi), the shape with the superior drag characteristics is designated as the current best shape.

17. The method of claim 15 wherein, in step (iii), the new shape is generated by modifying the current best shape, optionally based on the drag characteristics of the current best shape.

18. (canceled)

19. The method of claim 12, wherein forming the drag-reducing structure comprises:
forming a support structure; and
applying a surface cover to the support structure.

20. The method of claim 19, wherein forming the support structure comprises generating a support structure design based on the working parameters, and optionally generative design is used to generate the support structure design.

21. (canceled)

22. The method of claim 15, wherein forming the drag-reducing structure comprises forming the drag-reducing structure directly onto the ship.

23. A computer-implemented method for generating an optimal drag-reducing structure shape, the method comprising:
providing one or more working parameters; and
generating, based on the one or more working parameters, an optimal drag-reducing structure shape.

24. One or more computer-readable storage media comprising instructions which, when executed by a processor, cause the processor to perform the computer-implemented method of claim 23.
